(19) United States
(12) Patent Application Publication
(10) Pub. No.: US 2020/0094501 A1
(43) Pub. Date: Mar. 26, 2020

(54) PIGMENT-FREE COLOR CONTACT LENS COMPRISING A MICRO-PATTERN HAVING PHOTONIC CRYSTAL STRUCTURE

(71) Applicant: NAM GI MIN, Gimhae-si (KR)

(72) Inventor: NAM GI MIN, Gimhae-si (KR)

(21) Appl. No.: 16/432,419

(22) Filed: Jun. 5, 2019

(30) Foreign Application Priority Data
Sep. 21, 2018 (KR) 10-2018-0114211

(51) Int. Cl. B29D 11/00; G02B 1/04; G02C 7/04

(52) U.S. Cl. CPC B29D 11/00134; G02B 1/043; B29K 2105/0061; G02C 7/046; B29D 11/00326; G02C 7/049

(57) ABSTRACT

Provided is a color contact lens including a hydrogel and a micro-pattern in which a plurality of photonic crystal structures included in the hydrogel are dispersed. The color contact lens is capable of realizing colors without using a coloring agent. Also, the color contact lens according to the present invention has advantages in that no color distortion or change occurs even when the contact lens is swollen.

### CROSS-REFERENCE TO RELATED APPLICATIONS

This application claims priority under 35 U.S.C. § 119 to Korean Patent Application No. 10-2018-0114211, filed on Sep. 21, 2018, in the Korean Intellectual Property Office, the disclosure of which is incorporated herein by reference in its entirety.

### TECHNICAL FIELD

The following disclosure relates to a color contact lens, and more particularly, to a color contact lens capable of realizing colors without using a coloring agent.

### BACKGROUND

In general, contact lenses are small-sized lenses that are used in direct contact with the corneas of the eyes in place of glasses that give some discomfort to the lives of users. The contact lenses may be divided into therapeutic lenses, dioptric lenses, cosmetic lenses, and the like, depending on their intended use.

Contact lenses have an advantage in that they have a lesser distortion phenomenon than the glasses, and may be used to look like a real object. The glasses have a drawback in that a difference in refractive power of the eyeglasses caused by a difference in refractive power of both eyes may cause a headache and maladjustment of eyeglasses, or give rise to a distortion phenomenon in which an object looks smaller through one eye and looks bigger through the other. On the contrary, the contact lenses do not cause headache or a distortion phenomenon because the left and right lenses having different refractive power may be used as the contact lenses, and also may be conveniently used because the contact lenses are neither removed nor damaged when the user' eyes are directly hit by a ball while playing games such as basketball or football.

The contact lenses are divided into hard contact lenses and soft contact lenses according to whether their constituent materials are hard or soft. The hard contact lenses have an excellent vision correction rate, very high oxygen permeability, and a long life span, are easily washed, and are easily worn on or removed from the eyes, but have drawbacks in that one often fails to adjust from the eyeglasses due to a long period of adjustment, and the hard contact lenses has a slightly poor wearing sensation. Although the soft contact lenses are easily damaged or torn, the soft contact lenses have an advantage in that they have a short period of adjustment and a good wearing sensation.

In recent years, the soft contact lenses are prepared from a hydrogel composed of a hydrophilic polymer, and tend to be increasingly worn for a disposable use. Therefore, the contact lenses have increased functionality as cosmetic lenses, and there is also a sudden rise in demand for color contact lenses.

In general, the color contact lenses are prepared by printing a lens using a pigment. As such, one example of a method of printing a color contact lens is disclosed in Korean Patent Laid-Open Publication No. 2013-0120135. However, when a color contact lens is prepared in a printing fashion as described above, the pigment used may be harmful to the human body, and the pigment included in a print layer may be dissolved or detached to cause chemical damage to the eyes, and bending at a lens surface may be caused by the print layer, resulting in poor wearing sensation.

### SUMMARY

An embodiment of the present invention is directed to providing a color contact lens capable of realizing various colors without using a pigment.

Another embodiment of the present invention is directed to providing a color contact lens at which bending or deformation is not caused upon the swelling of lenses.

In one general aspect, a color contact lens according to the present invention includes a hydrogel and a micro-pattern in which a plurality of photonic crystal structures included in the hydrogel are dispersed.

The photonic crystal structures may include opal or inverse opal structures.

The photonic crystal structures may be in a lamellar or hemispherical shape having a thickness of 1 μm to 50 μm.

The photonic crystal structures may have substantially spherical particles or spherical pores regularly arranged therein, and a wall material of the photonic crystal structures may include a polymer having a water content of 0 to 30%.

The wall material of the photonic crystal structures may include a cross-linked polymer which is not swellable in water.

The polymer of the wall material may be prepared by polymerizing a monomer composition including 50 mol % or more of a multifunctional monomer containing two or more polymerizable functional groups, based on the total mole of the monomer in the monomer composition.

The photonic crystal structures may be derived from colloidal photonic crystal structures in which crystals are spontaneously formed by a repulsive force acting between colloidal particles and a solvent.

The color contact lens may not include a coloring agent.

The micro-pattern may be included in an annular peripheral zone.

In another general aspect, a color contact lens according to the present invention includes an optical zone through which a contact lens wearer's line of vision passes; and an annular peripheral zone including a plurality of photonic crystal structures dispersed around the optical zone, wherein the plurality of photonic crystal structures are encapsulated with a lens material.

The plurality of photonic crystal structures dispersed in the annular peripheral zone may form an annular, semi-annular, crescentic, or arch-shaped strip.

The lens material may include an acrylic or silicone-based hydrogel.

A water content of the lens material may be characterized in that the water content of the lens material is higher than water contents of the photonic crystal structures.

The photonic crystal structures may have an in-plane long-axis diameter of 10 μm to 1,000 μm, and the plurality of photonic crystal structures may have the same or different long-axis diameters.

The photonic crystal structures may have substantially spherical particles or spherical pores regularly arranged therein, and the spherical particles or spherical pores may have a diameter of 50 nm to 500 nm.

A gap between the photonic crystal structures may be in a range of 10 μm to 500 μm.

The contact lens may have a water content of 35% or more and an oxygen permeability (Dk) of 50 or more.

In still another general aspect, a method of preparing a color contact lens according to the present invention includes: (A) preparing a colloidal dispersion including colloidal particles and a multifunctional monomer; (B) forming regularly arranged colloidal crystals from the colloidal dispersion; (C) curing the colloidal crystals to prepare photonic crystal structures; (D) disposing the photonic crystal structures in a mold and filling the mold with a polymerizable composition; and (E) curing the polymerizable composition to encapsulate the photonic crystal structures with a lens material.

The method may further include removing the colloidal particles from the photonic crystal structures after the step (C).

### BRIEF DESCRIPTION OF THE DRAWINGS

FIG. 1 is a diagram showing a stereoscopic configuration of a color contact lens according to the present invention.

FIG. 2 is a top view of the color contact lens shown in FIG. 1.

FIG. 3 is a cross-sectional view taken along line III-III shown in FIG. 2.

FIG. 4 is an enlarged diagram showing photonic crystal structures shown in FIG. 3.

FIG. 5 is a diagram showing a stereoscopic layout configuration of pores included in the photonic crystal structures shown in FIG. 3.

FIG. 6 shows an optical microscope image and a scanning electron microscope image of a contact lens in which a brown color is realized according to the size of the pores included in the photonic crystal structures.

FIG. 7 shows an optical microscope image and a scanning electron microscope image of a contact lens in which a green color is realized according to the size of the pores included in the photonic crystal structures.

FIG. 8 shows an optical microscope image and a scanning electron microscope image of a contact lens in which a blue color is realized according to the size of the pores included in the photonic crystal structures.

FIG. 9 shows images of a contact lens, which includes the photonic crystal structures having an annular ring pattern, before and after swelling.

FIG. 10 shows images of a contact lens, which includes the photonic crystal structures having poly(HEMA) as a wall material, before and after the swelling.

### DETAILED DESCRIPTION OF EMBODIMENTS

Hereinafter, the present invention will be described in detail with reference to the accompanying drawings. The drawings presented hereinbelow are shown as one example to sufficiently provide the scope of the present invention to those skilled in the art. Therefore, it should be understood that the present invention may be embodied in various forms, but is not intended to be limiting in the drawings presented hereinbelow. In this case, the drawings presented hereinbelow may be shown in an exaggerated manner to make the scope of the present invention more clearly apparent.

Unless otherwise defined, all technical and scientific terms used in the specification of the present invention have the same meaning as commonly understood by one of ordinary skill in the art to which the present invention pertains. In the following description and the accompanying drawings, a description of known functions and configurations, which unnecessarily obscure the subject matter of the present invention, will be omitted.

Also, the singular forms “a,” “an,” and “the” used in the specification of the present invention refer to those including plural referents unless the context clearly dictates otherwise.

In addition, the units used without any particular comments in the specification of the present invention are based on weight. For example, the units of % or percentage refer to a percent (%) by weight or weight percentage.

Also, unless otherwise defined in this specification of the present invention, a molecular weight of a polymer refers to a weight average molecular weight of the polymer.

Additionally, unless otherwise defined in this specification of the present invention, an average particle size of particles refers to a D₅₀ value obtained using a particle size analyzer.

In addition, a numerical range used in this specification of the present invention is meant to include its upper and lower limits and all possible combinations of all values falling within these limits, increments logically derived from the shapes and widths of defined ranges, all double-defined values, and upper and lower limits of the numerical ranges defined in different types. As one example, it should be understood that, when the molecular weight is defined in a range of 100 to 10,000, particularly in a range of 500 to 5,000, a numerical range of 500 to 10,000 or 100 to 5,000 is also described in this specification of the present invention. Unless otherwise particularly defined in this specification of the present invention, all values falling out of this numerical range that may occur due to the rounding off of the experimental errors or values also fall within the defined numerical ranges.

Also, in the specification of the present invention, the expression “comprise(s)” is intended to be open-ended transitional phrases having an equivalent meaning with “include(s),” “have,” “has,” “contain(s),” and “is(are) characterized by,” and does not exclude elements, materials, or steps, all of which are not further recited herein. Also, the expression “consist(s) essentially of” means that one element, material or step, which is not recited in combination with the other elements, materials, or steps, may be present at an amount having no unacceptably significant influence on at least one basic and novel technical idea of the invention. Also, the expression “consist(s) of” means the presence of only the elements, materials or steps defined herein.

In addition, in this specification of the present invention, a hydrogel refers to a solid material that includes a hydrophilic polymer having a swelling property using water as a solvent. Also, the hydrogel refers to a substance that does not exhibit fluidity because it is not substantially deformed due to its high viscosity in a normal state or has three-dimensionally (3D) physical or chemical cross-linking bonds.

Further, in this specification of the present invention, the term “polymer” refers to a product of polymerization of one or more monomers, and may be used to have the same meaning as described in the “high-molecular compound.” In this case, unless otherwise defined, the polymer is meant to be inclusive of homopolymers as well as interpolymers, copolymers, terpolymers, and the like, and also includes blends and modifications of any of the foregoing, including block, graft, addition or condensation forms of the polymers.

A color contact lens according to the present invention is characterized by including a hydrogel and a micro-pattern in which a plurality of photonic crystal structures included in the hydrogel are dispersed.

The hydrogel corresponds to a material of the contact lens, and may be included as a matrix forming an optical zone and a peripheral zone of a lens. In this case, the hydrogel may have an internetworking configuration formed by cross-linking a plurality of main polymer chains with each other.

Hydrogels known in the related art may be used as the hydrogel without any limitation. One example of the hydrogel may be an acrylic or silicone-based hydrogel, preferably a hydrophilic acrylic hydrogel or a hydrophilic silicone-based hydrogel. Materials known in the related art may be used as a monomer or macromer forming the hydrogel without any limitation. Preferably, the hydrogel may be substantially transparent, and may have a permeability in a visible light range of 90% or more, more particularly a permeability of 95% or more and 100% or less, as determined at a thickness of 100 μm.

The micro-pattern means that a plurality of photonic crystal structures are formed so that the plurality of photonic crystal structures are dispersed in the hydrogel. The photonic crystal structures may be encapsulated into the hydrogel in the form of separate particles, and each of the particles in the photonic crystal structures may be spaced apart at a predetermined distance from each other to form a dispersed phase in the hydrogel.

When the plurality of photonic crystal structures are spaced apart at a predetermined distance from each other to form a dispersed phase in the hydrogel, a shape of the contact lens is not bent or deformed even when water contents of the photonic crystal structures is different from a water content of the hydrogel, which is a material of the contact lens, upon the hydration or swelling of the hydrogel. When the photonic crystal structures are dispersed and encapsulated into a large area of lamellar photonic crystal structures rather than the hydrogel, there is a difference in water content between the photonic crystal structures and the hydrogel, and thus a difference in swelling degree may cause bend or deform the shape of the contact lens. Therefore, this is not desirable because this may highly debase the users' wearing sensation.

The 20 or more photonic crystal structures may be included in one color contact lens. Specifically, the number of the photonic crystal structures may be greater than or equal to 100, 200, 500, or 1,000, and may be less than or equal to 2,000, but this is just one embodiment, and the present invention is not limited thereto. Also, the photonic crystal structures may be included in one color contact lens at a content of 0.1% by weight to 30% by weight, based on the total dry weight of the color contact lens.

The photonic crystal structures may be opal or inverse opal structures, and the opal or inverse opal structures may mean that a plurality of particles or pores are arranged in a 3D long-range order in the structures.

The photonic crystal structures may have a photonic band gap by periodically changing a dielectric constant at substantially the half of the wavelengths of light. Photons having a level of energy corresponding to the photonic band gap may not propagate into photonic crystals due to the very low state density of the photonic crystals. When the photonic band gap is present in a region of visible rays, this immediately appears as a reflection color. As a result, the photonic crystal structures may show colors without using a pigment. When the colloidal particles are regularly arranged, the photonic crystal structures may be formed. In this case, the photonic crystal structures may show a reflection color, and the color is a color corresponding to the band gap of the photonic crystals. The reflection color of the colloidal photonic crystal structures may be adjusted by colloids, an index of refraction of a background material, a crystal structure, the size of particles, a gap between the particles, and the like.

The opal structure may refer to a crystal-phase structure obtained by regularly arranging polymer or inorganic colloidal particles, specifically a face-centered cubic (FCC) crystal-phase structure or a non-close-packed FCC crystal-phase structure. The opal structure may, for example, be prepared by a method such as direct printing, photolithography, stamping, solvent evaporation, or sedimentation. In one non-limiting example of the solvent evaporation method, when colloidal particles having a particle size of 50 nm to 500 nm are dispersed in a medium such as water or alcohol, and the medium is then slowly evaporated, the colloidal particles may be packed in the closest configuration due to a capillary force exerted between the particles, and the crystal-phase structure may be obtained accordingly. In this case, the colloidal particles may be preferably monodispersed colloidal particles, and a particle size distribution of the colloidal particles may have a relative standard deviation of 10% or less, or preferably a relative standard deviation of 0.1% to 5%.

The inverse opal structure refers to a structure having a number of pores in a wall material, wherein the structure is obtained by filling an empty space of the opal structure with a wall material, followed by etching the polymer or inorganic colloidal particles forming the opal structure, dissolving the colloidal particles in a solvent, or removing the colloidal particles by means of thermal treatment. When light incident on the inverse opal structure has wavelengths in a band bap of the inverse opal structure, the light does not pass through the inverse opal structure, and thus may be selectively reflected to show rainbow structural colors in a region of visible rays. As described above, a color expressed by the crystal structure through the regular arrangement of the particles or pores may be named a structural color.

Based on the total volume of the photonic crystal structures, a volume fraction of the colloidal particles or a volume fraction of the pores is sufficient, and is not particularly limited as long as the colloidal particles and pores have a level of volume fraction to show a certain structural color due to the scattering of light. For example, the volume fraction may be greater than or equal to 20%, 40%, 50%, 60%, or 70%, and may be less than or equal to 80%.

The photonic crystal structures may be in a lamellar or hemispherical shape having a thickness of 1 μm to 50 μm, preferably a thickness of 2 μm to 40 μm, and more preferably a thickness of 2 μm to 20 μm.

When the spherical particles or spherical pores are sufficiently distributed in a 3D arrangement manner within this numerical range, the photonic crystal structures may exhibit excellent color development characteristics of the structural color, and a process of preparing the colloidal particles to form the pores may also be facilitated upon preparation of the inverse opal structure. More specifically, for the purpose of good expression of the structural color in the inverse opal structure, the pores should be stacked in five or more layers in a direction of depth (d2) of the photonic crystal structures. However, when contact lenses 10 are worn over human eyes, the tears are allowed to flow into pores 34 included in the photonic crystal structures. In this case, the pores 34 may be preferably stacked in ten or more layers in a direction of depth (d2) of the micro-pattern 30, depending on a difference in index of refraction between the air and water.

The photonic crystal structures may have an in-plane long-axis diameter of 10 μm to 1000 μm, preferably an in-plane long-axis diameter of 20 μm to 500 μm, and more preferably an in-plane long-axis diameter of 50 μm to 200 μm. The plurality of photonic crystal structures may have the same or different long-axis diameters. It is desirable that, when the photonic crystal structures have the thickness and the in-plane long-axis diameter, the shape of the contact lens is not bent or deformed even when the photonic crystal structures have a non-swelling property in water during the hydration or swelling of the hydrogel serving as a material of the contact lens.

More specifically, a ratio of the thickness of the photonic crystal structures with respect to the in-plane long-axis diameter thereof may be in a range of 1 to 100, preferably 2 to 50, and more preferably 5 to 20, and the photonic crystal structures may be in a lamellar shape.

According to one embodiment of the color contact lens according to the present invention, the photonic crystal structures may scatter light with wavelengths of 350 nm to 750 nm to show colors because the photonic crystal structures include an opal or inverse opal structure. The color contact lens may scatter light in a region of visible rays to realize colors without using a coloring agent such as a pigment or a dye. Therefore, the color contact lens has an advantage in that an additional printing process is not required even when the color contact lens does not include the coloring agent.

According to one embodiment of the color contact lens according to the present invention, the photonic crystal structures may be disposed in an annular peripheral zone of the contact lens.

The contact lens includes an optical zone through which a contact lens wearer's line of vision passes, and an annular peripheral zone including a plurality of photonic crystal structures dispersed around the optical zone. Because a user's line of vision passes through the optical zone, a hydrogel serving as a material of the contact lens is disposed in the optical zone. Also, because the annular peripheral zone is a zone through which a user's line of vision does not pass, the annular peripheral zone may be used to realize an aesthetic effect. The plurality of photonic crystal structures according to the present invention may be disposed to be dispersed in the annular peripheral zone.

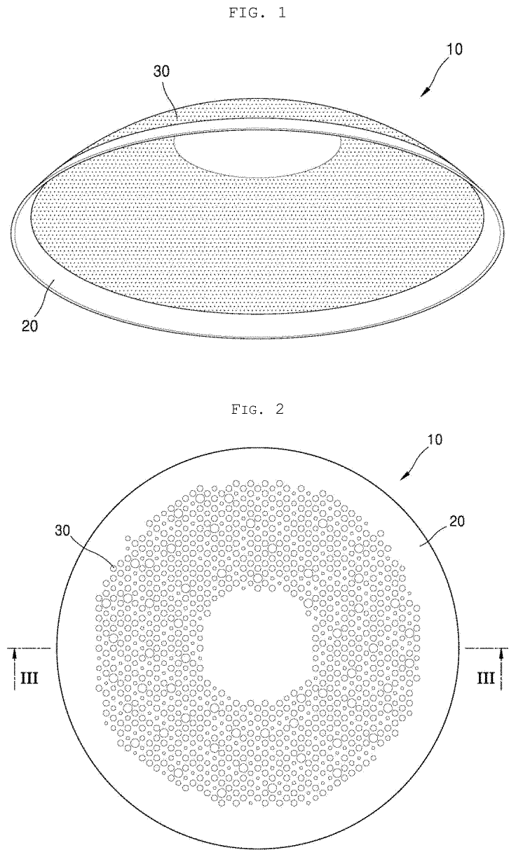

Referring to FIG. 1, the contact lens according to one embodiment of the present invention may be in a hemispherical shape. In this case, because a lens wearer's line of vision passes through the optical zone, the photonic crystal structures are not disposed in the optical zone and the plurality of photonic crystal structures are disposed in the annular peripheral zone to form an annular strip.

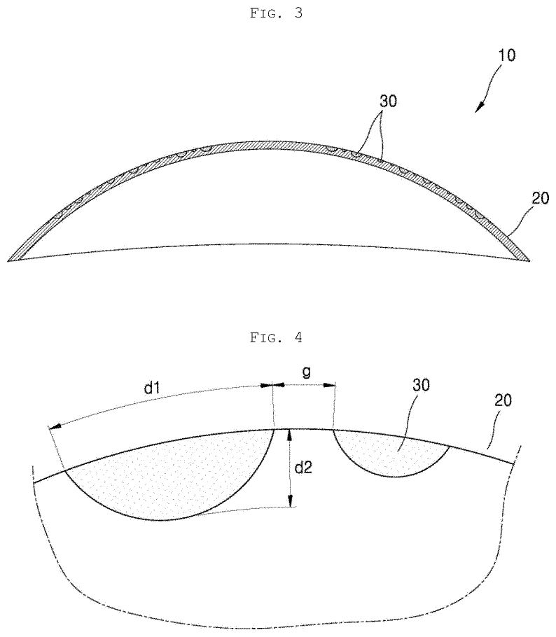

FIG. 2 shows a top view of a contact lens according to one embodiment of the present invention, showing that a micro-pattern in which a plurality of photonic crystal structures are densely disposed in an annular peripheral zone is formed. The micro-pattern has an annular strip, and the photonic crystal structures may be disposed to the end portion of the lens. Also, because only the hydrogel is also included in the end portion of the lens, the micro-pattern may be disposed in some zones around a circumferential surface of the contact lens.

The photonic crystal structures may be physically or chemically encapsulated into the hydrogel. When the photonic crystal structures are physically encapsulated, the photonic crystal structures may be mixed and polymerized with a polymerizable composition forming a hydrogel in a mold, and then encapsulated into the hydrogel. When the photonic crystal structures are chemically encapsulated, a reactive functional group positioned on surfaces of the photonic crystal structures may react with the polymerizable composition forming a hydrogel in the mold, and then may be more stably encapsulated into the hydrogel.

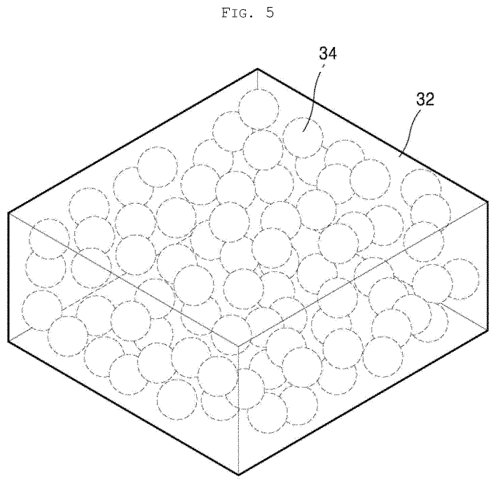

FIG. 3 shows a cross-sectional view of the contact lens according to one embodiment of the present invention, showing that a plurality of photonic crystal structures are encapsulated into a hydrogel in the form of separate particles. In this case, the respective photonic crystal structures are spaced apart at a predetermined distance from each other to form a dispersed phase in the hydrogel, thereby forming a micro-pattern.

According to one specific embodiment, the photonic crystal structures may be first disposed at a certain position in the mold, and the mold may be filled with a polymerizable composition forming a hydrogel. Then, the photonic crystal structures may be polymerized and encapsulated into the hydrogel. In this case, after the polymerization is completed, the plurality of photonic crystal structures disposed at a certain position in the mold may be transferred into the hydrogel to form a micro-pattern of the contact lens. The hydrogel whose polymerization is completed refers to a contact lens including the micro-pattern, and the contact lens may be in a hemispherical shape. The micro-pattern may be positioned so that the micro-pattern can be encapsulated into the hemispherical contact lens, and may be positioned towards a convex surface of the contact lens.

Preferably, a zone positioned in the lens in which the photonic crystal structures are disposed is covered with the hydrogel so that a hydrogel-coated layer may be included on the photonic crystal structures. More specifically, a transparent coating may be formed on the micro-pattern by applying a layer of polymerizable composition solution forming a hydrogel onto a surface of the color contact lens, which includes the micro-pattern in which the photonic crystal structures are dispersed, and polymerizing the layer of polymerizable composition solution. A transparent hydrogel-coated layer may prevent the photonic crystal structures from being directly exposed towards a convex surface of the lens, thereby improving the user's wearing sensation. Also, because the photonic crystal structures have a non-swelling property such as low water content, a moisture content of the lens surface may be reduced when the photonic crystal structures are directly exposed outwards a convex surface of the contact lens, thereby causing discomfort when worn for a long period of time, and causing problems such as fouling caused by adsorption of proteins. However, when the transparent hydrogel-coated layer is formed on the photonic crystal structures, an increase in the moisture content of the lens surface may be promoted, thereby significantly lowering the side effects in the cornea, such as eye redness, drying sensation, and foreign body sensation, even when worn for a long period of time.

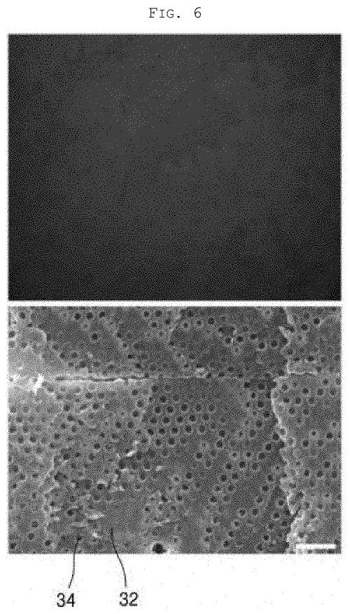

FIG. 4 shows an enlarged diagram showing some of the photonic crystal structures in the micro-pattern shown in FIG. 3, and shows that the respective photonic crystal structures may have the same or different long-axis diameters. In this case, the respective photonic crystal structures may have the same or different thicknesses.

Each of the photonic crystal structures may be in various shapes such as a lamellar shape, a hemispherical shape, and the like, and is not limited to certain shapes. For example, each of the photonic crystal structures may include hemispherical shape as shown in FIG. 4. A gap g between the neighboring photonic crystal structures may be in a range of 10 μm to 500 μm, preferably in a range of 50 μm to 200 μm. When the hydrogel is hydrated or swollen within this numerical range, the shape of the contact lens may not be bent or deformed even when there is a difference in water content between the photonic crystal structures and the hydrogel serving as a material of the contact lens. Also, the photonic crystal structures have an advantage in that, when a gap between the respective photonic crystal structures is observed with the naked eye, it is impossible to identify the gap between the respective photonic crystal structures with the naked eye, but it is possible to identify the gap as one strip in which the micro-pattern consisting of the plurality of photonic crystal structures shows colors.

According to one embodiment of the color contact lens of the present invention, the photonic crystal structures may have substantially spherical particles or spherical pores regularly arranged therein, and a wall material of the photonic crystal structures may include a polymer having a water content of 0 to 30%.

In this specification of the present invention, “substantially spherical shape” refers to roughly a complete spherical shape, that is, a spherical shape in which a difference between the maximum diameter and the minimum diameter is less than 10%, as determined on any cross section of the spherical shape, but the present invention is not limited thereto. In the initial state, the pores may also be in a distorted spherical shape.

A photonic crystal structure having substantially spherical particles regularly arranged therein refers to an opal structure, and the particles may include high-molecular particles or inorganic particles. One non-limiting embodiment of such particles may include styrene-butadiene rubber (SBR) particles, polybutadiene rubber particles, nitrile rubber particles, acrylic rubber particles, acrylonitrile-butadiene-styrene (ABS) particles, polyvinylidene fluoride particles, vinylacetate-ethylene copolymer particles, polystyrene (PS) particles, polymethylmethacrylate (PMMA) particles, or silica particles, but this is just one embodiment, and the present invention is not limited thereto.

The polymer particles are not particularly limited as long as stable particles can be produced by emulsion polymerization or suspension polymerization. An example of a method of preparing the substantially spherical inorganic particles may be found in U.S. Pat. No. 4,775,520 A. As a method of preparing the substantially spherical monodispersed high-molecular particles or inorganic particles, various preparation methods are known in the related art. In this case, the known preparation methods may be used without any limitation, and thus a detailed description of the specific preparation methods will be omitted.

An empty space of the opal structure may be filled with a wall material, and thus stability of the opal structure may be improved without any destruction of crystallinity in which the spherical particles are regularly arranged through the wall material.

The photonic crystal structures having the substantially spherical pores regularly arranged therein refer to an inverse opal structure, and the inverse opal structure may be prepared by filling an empty space of the opal structure with a wall material, followed by etching the high-molecular or inorganic colloidal particles forming the opal structure, dissolving the colloidal particles in a solvent, or removing the colloidal particles by means of thermal treatment.

The wall material of the photonic crystal structures may include a polymer having a water content of 0 to 30%. The water content of the wall material is particularly in a range of 0 to 20%, more particularly in a range of 0 to 10%. The polymer included in the wall material may be a polymer having a non-swelling property in water, and preferably may be a non-swelling cross-linked polymer.

The polymer included in the wall material of the photonic crystal structures may be prepared by polymerizing a monomer composition including a multifunctional monomer containing two or more polymerizable functional groups. The multifunctional monomer may be a multifunctional vinyl-based monomer or a multifunctional acrylic monomer, and may preferably include 50 mol % or more, particularly 70 mol % or more, and more particularly 80 mol % or more and 100mol % or less, of the multifunctional monomer, based on the total moles of monomers in the monomer composition.

The number of the polymerizable functional groups in the multifunctional monomer may be in a range of 2 to 10, particularly in a range of 2 to 8, and more particularly in a range of 2 to 6, but the present invention is not limited thereto.

Specific examples of the multifunctional acrylic monomer that may be used herein include one or combinations of two or more selected from the group consisting of glycerin-(ethylene oxide)₃ trimethacrylate, pentaerythritol-(ethylene oxide)₄ tetramethacrylate, Ethoxylated trimethylolpropane triacrylate (ETPTA), trimethylolpropane triacrylate, pentaerythritol triacrylate, ditrimethylol propane tetraacrylate, and tetramethylol methane tetraacrylate, but this is just one embodiment, and the present invention is not limited thereto.

According to one embodiment of the color contact lens of the present invention, the photonic crystal structures may be derived from colloidal photonic crystal structures in which crystals are spontaneously formed by a repulsive force acting between the colloidal particles and the solvent. The photonic crystal structures may be advantageous for a preparation process in that the photonic crystal structures obtained through a self-assembly process of colloids may be prepared with low expense by regularly arranging the colloidal particles on a large area.

Also, the present invention provides a color contact lens including an optical zone through which a contact lens wearer's line of vision passes; and an annular peripheral zone including a plurality of photonic crystal structures dispersed around the optical zone, characterized in that the plurality of photonic crystal structures are encapsulated with a lens material.

The lens material may be a water-swelling hydrogel, and may be included as a matrix forming an optical zone and a peripheral zone of a lens. In this case, the hydrogel may have an internetworking configuration in which a plurality of main polymer chains are cross-linked with each other. The photonic crystal structures may be physically or chemically encapsulated into the hydrogel so that the hydrogel can be stably positioned in the contact lens without detaching the photonic crystal structures from the contact lens.

Hydrogels known in the related art may be used as the hydrogel without any limitation, and the hydrogel may be prepared by polymerizing a polymerizable composition including one or more monomers containing a polymerizable functional group.

The silicone-based hydrogel may be prepared by cross-linking a polymerizable composition including a silicone-based macromer, an acrylic monomer, an initiator, and a cross-linking agent. The silicone-based macromer may be a monofunctional or difunctional monomer including polydimethylsiloxane (PDMS) at the main chain thereof and containing a polymerizable functional group at the end thereof. The acrylic hydrogel may be prepared by cross-linking a polymerizable composition including an acrylic monomer, an initiator, and a cross-linking agent.

The polymerizable composition for preparing a hydrogel preferably has a viscosity of 10 to 20,000 cps, and more preferably a viscosity of 100 to 15000 cps, as determined at 25° C. When the polymerizable composition is injected into a mold within this viscosity range, it is desirable that the polymerizable composition may penetrate into surfaces of the photonic crystal structures so that the photonic crystal structures can be effectively encapsulated into the hydrogel.

The acrylic monomer included in the polymerizable composition for preparing a hydrogel may be a hydrophilic monomer. In this case, one or two or more acrylic monomers may be included in the polymerizable composition. The hydrophilic monomer is not particularly limited, and hydrophilic monomers commonly used in the related art, for example, a hydrophilic acrylic monomer or a hydrophilic silicone-acrylic monomer, may be used as the hydrophilic monomer.

Specific examples of the hydrophilic acrylic monomer may include one or more selected from C1-C15 hydroxyalkyl methacrylates substituted with 1 to 3 hydroxyl groups, C1-C15 hydroxyalkyl acrylates substituted with 1 to 3 hydroxyl groups, acrylamides, vinyl pyrrolidone, glycerol methacrylate, acrylic acid, and methacrylic acid. More specific examples of the hydrophilic acrylic monomer may include one or more selected from 2-hydroxyethyl methacrylate (HEMA), N,N-dimethyl acrylamide (DMA), N-vinyl pyrrolidone (NVP), glycerol monomethacrylate (GMMA), and methacrylic acid (MAA).

Also, specific examples of the hydrophilic silicone-acrylic monomer may include one or more selected from tris(3-methacryloxypropyl)silane, 2-(trimethylsilyloxy) ethylmethacrylate, 3-tris(trimethylsilyloxy)silylpropyl methacrylate, 3-methacryloxypropyl tris(trimethylsilyl)silane (MPTS), 3-methacryloxy-2-(hydroxypropyloxy)propyl bis(trimethylsiloxy)methylsilane, and 4-methacryloxybutyl-terminated polydimethylsiloxane.

In addition to the hydrophilic monomers, a hydrophobic monomer may also be used together, when necessary. In this case, the hydrophobic monomer is not particularly limited, and hydrophobic monomers commonly used in the related art, for example, a hydrophobic acrylic monomer, and the like, may be used as the hydrophobic monomer.

An alkyl acrylate monomer and an alkyl methacrylate monomer may be used as the hydrophobic acrylic monomer. More specific examples of the hydrophobic acrylic monomer may include one or more selected from methyl acrylate, methyl methacrylate, ethyl acrylate, ethyl methacrylate, n-propyl acrylate, n-propyl methacrylate, n-butyl acrylate, n-butyl methacrylate, stearyl acrylate, stearyl methacrylate, and the like. Also, monomers having a high glass transition temperature (T_{g}), for example, cyclohexyl methacrylate, tert-butyl methacrylate, isobornyl methacrylate, and a mixture thereof may also be used to enhance mechanical properties of the contact lens.

The polymerizable monomer may be included at a content of 40 to 100% by weight, and more particularly a content of 50 to 90% by weight, based on the total weight of the polymerizable composition, but the present invention is not limited thereto.

Also, the hydrophilic monomer may be included at a content of 20 to 99% by weight, particularly a content of 30 to 90% by weight, and particularly a content of 40 to 80% by weight, based on the total weight of the polymerizable composition.

The cross-linking agent may be a vinyl-based or acrylic compound having two or more polymerizable functional groups. For example, one or more selected from ethylene glycol dimethacrylate (EGDMA), diethylene glycol methacrylate (DGMA), divinylbenzene, and trimethylolpropane trimethacrylate (TMPTMA) may be used. Also, the cross-linking agent may be preferably present in the polymerizable composition at a content of 0.005 to 5% by weight, and more particularly a content of 0.010 to 3% by weight.

The initiator is used to polymerize the polymerizable composition, and a thermal initiator or a photoinitiator may be selected herein. For example, one or more selected from azodiisobutyronitrile (AIBN), benzoin methyl ether (BME), 2,5-dimethyl-2,5-di-(2-ethylhexanoylperoxy)hexane, dimethoxyphenyl acetophenone (DMPA), and Irgacure 2100 may be used as the initiator, but the present invention is not limited thereto. The initiator may be present in the polymerizable composition at a content of 0.005 to 2.000% by weight, and more particularly a content of 0.010 to 1.500% by weight, but the present invention is not limited thereto.

The color contact lens may have a thickness of 10 μm to 150 μm. In this case, the thickness of the contact lens may vary depending on the zones. For example, the contact lens may become thinner towards the peripheral zone. The annular peripheral zone in which the photonic crystal structures are positioned may have a thickness of 10 μm to 100 μm, particularly a thickness of 15 μm to 70 μm, and more particularly a thickness of 20 μm to 50 μm. To stably encapsulate the photonic crystal structures into the contact lens, the thickness of the annular peripheral zone is characterized in that it is higher than the thickness of the photonic crystal structures.

According to one embodiment of the color contact lens of the present invention, the plurality of photonic crystal structures may be dispersed in the annular peripheral zone to form a strip. When the strip which the plurality of photonic crystal structures are dispersed to form is observed with the naked eye, a gap between the respective photonic crystal structures is not identified with the naked eye, and may be identified as one strip consisting of the plurality of photonic crystal structures to show colors.

The plurality of photonic crystal structures dispersed in the annular peripheral zone may form an annular, semi-annular, crescentic, or arch-shaped strip. To allow the strip composed of the plurality of photonic crystal structures to have a certain shape, according to one specific embodiment, the photonic crystal structures may be encapsulated into the hydrogel, first of all, by disposing the photonic crystal structures at a certain position to have a strip in a certain shape in a mold, filling the mold with a polymerizable composition forming a hydrogel, and polymerizing the polymerizable composition. After the polymerization is completed, the plurality of photonic crystal structures disposed at a certain position in the mold through this procedure may be transferred into the hydrogel to form a strip of the contact lens in a certain shape.

According to one embodiment of the color contact lens of the present invention, the water content of the lens material is characterized in that it is higher than the water contents of the photonic crystal structures.

The lens material may be a hydrogel, and the hydrogel preferably has a high water content in order to exhibit a high wearing sensation without any side effects such as eye redness, and drying sensation. On the contrary, the wall material of the photonic crystal structures preferably has a low water content. When wall material of the photonic crystal structures is a polymer having high a water content, the volume expansion may occur during hydration to destruct the opal structure or the inverse opal structure, which makes it difficult to express a structural color. Therefore, in order to realize colors by expressing the structural color and simultaneously allow a user to have a high wearing sensation, it is advantageous that the hydrogel serving as the lens material has a high water content, and the photonic crystal structures have a low water content.

The water content of the hydrogel serving as the lens material may be greater than or equal to 35%, preferably 40%, or 50%, and may be less than or equal to 80%. Meanwhile, the water content of the wall material of the photonic crystal structures may be in a range of 0 to 30%, particularly a range of 0 to 20%, and more particularly a range of 0 to 10%. The polymer included in the wall material may be a polymer having a non-swelling property in water, preferably a non-swelling cross-linked polymer.

More specifically, a ratio of the water content of the hydrogel serving as the lens material and the water content of the wall material of the photonic crystal structures may be in a range of 1.3 to 100, particularly a range of 2 to 50, and more particularly a range of 5 to 50.

As the color contact lens according to one embodiment of the present invention has an asymmetric water content as described above, the contact lens may have a water content of 35% or more and an oxygen permeability (Dk) of 50 or more. Preferably, the water content of the contact lens may be greater than or equal to 50% or 60%, and may be less than 80%, and the oxygen permeability (Dk) may be preferably greater than or equal to 70 or 100, and may be less than 150.

According to the color contact lens of the present invention, the photonic crystal structures may have substantially spherical particles or spherical pores regularly arranged therein, and the spherical particles or spherical pores may have a diameter of 50 nm to 500 nm.

According to one specific embodiment, when the photonic crystal structures are inverse opal structures, the diameter of the pores 34 may vary depending on the colors expressed by the photonic crystal structures 30. In general, the Bragg's diffraction equation (Equation 1) in the lattice arranged in a face-centered cubic configuration may be useful in estimating the wavelengths of reflected light.

$$λ = 2 {dn}_{eff} = {( \frac{π}{3 \sqrt{2 φ}} )}^{\frac{1}{3}} {( \frac{8}{3} )}^{\frac{1}{2}} {D ( {n}_{p}^{2} φ + {n}_{m}^{2} ( 1 - φ ) )}^{\frac{1}{2}} \qquad [ Equation 1 ]$$

wherein φ is a volume fraction of pores, D is a diameter of the pores, nₚ is an index of refraction of the pores, and nₘ is an index of refraction of a wall material of the photonic crystal structures. For example, when the wall material of the photonic crystal structures is composed of ETPTA (n=1.471), a volume fraction of the pores (n=1) is 33% by volume, and a diameter of the pores 34 is in a range of 140 to 170 nm, the photonic crystal structures reflect a blue color. Also, the photonic crystal structures reflect a green color when the diameter of the pores 34 is in a range of 170 to 190 nm, and reflect a red color when the diameter of the pores 34 is in a range of 200 to 240 nm.

When the diameter of the pores 34 is less than 50 nm, the wavelengths of light reflected by the pores are shorter than a region of visible rays, which makes impossible to properly express the colors. On the other hand, when the diameter of the pores 34 is greater than 500 nm, the wavelengths of light reflected by the pores is longer than the region of visible rays, which makes impossible to properly express colors. Generally, when the pores 34 are arranged in a face-centered cubic configuration in the photonic crystal structures 30, a gap between the pores 34 may be physically maintained at a diameter 0.2-fold to 0.5-fold higher than that of the pores 34. The gap between the pores 34 may be determined by the size and volume fraction of the colloidal particles mixed to form the pores 34.

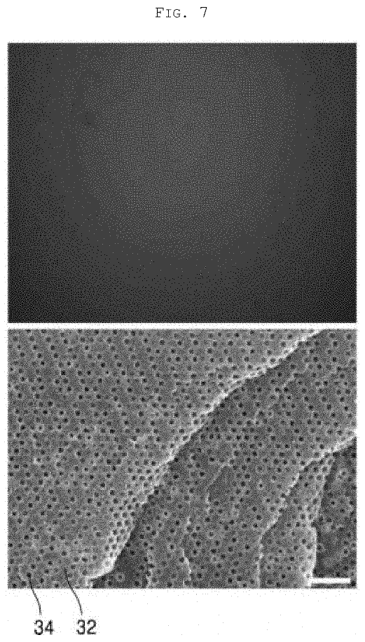

Referring to FIGS. 6 to 8, each of the drawings shows an optical microscope image and a scanning electron microscope image of the color contact lens 10 including photonic crystal structures with an inverse opal structure including components as described above. It can be seen that the color contact lens 10 according to one embodiment of the present invention expresses brown, green, and blue colors, depending on the size of the pores 34 formed in the photonic crystal structures. As shown in FIGS. 6 to 8, it is suggested that the colors expressed by the color contact lens 10 may be determined depending on the size of the pores 34 included in the photonic crystal structures 30.

The color contact lens according to one embodiment of the present invention may be configured so that each of the annular peripheral zone and the optical zone adjacent to the annular peripheral zone can have substantially the same curved path in a central direction of the optical zone upon water swelling.

More specifically, when the annular peripheral zone and the optical zone have different water contents, local stress may occur during the hydrating or swelling of the contact lens. As one example, because the hydrogel having a high water content is included in the optical zone of the contact lens and the photonic crystal structures having a low water content are included in the peripheral zone, stress is caused at the interface between the optical zone and the annular peripheral zone due to a difference in water content between the hydrogel and the photonic crystal structures. Because such stress causes bending or deformation at the interface between the optical zone and the annular peripheral zone, it is impossible to obtain a smooth hemispherical contact lens. However, the color contact lens according to one embodiment of the present invention is positioned so that a plurality of photonic crystals can be dispersed in the annular peripheral zone, thereby minimizing stress at the interface between the optical zone and the annular peripheral zone. Therefore, a smooth hemispherical contact lens may be obtained without any bending or deformation at the interface between the optical zone and the annular peripheral zone. That is, although the water content of the hydrogel serving as the lens material is higher than the water contents of the photonic crystal structures in the color contact lens according to the present invention, the color contact lens is not bent or deformed. Therefore, the annular peripheral zone and the optical zone adjacent to the annular peripheral zone may have substantially the same curved path in a central direction of the optical zone upon the swelling.

According to one embodiment of the color contact lens of the present invention, when the lens material is a soft color contact lens in which a hydrogel having a high water content is used, the hydrogel having a high water content is included in the optical zone. Therefore, the center of the optical zone may have a stiffness value of 1 psi·mm² or less. Also, the annular peripheral zone may have a stiffness value of 5 psi·mm² or less when the annular peripheral zone includes the photonic crystal structures. More preferably, the center of the optical zone may have a stiffness value of 0.8 psi·mm² or less, more preferably 0.5 psi·mm² or less, and may have a stiffness value of 0.05 psi·mm² or more. The annular peripheral zone may have a stiffness value of 4 psi·mm² or less, more preferably 2 psi·mm² or less, and may have a stiffness value of 0.5 psi·mm² or more.

The color contact lens according to one embodiment of the present invention may be a soft contact lens having excellent flexibility, and the stiffness value of the center of the optical zone may be higher than the stiffness value of the annular peripheral zone. The stiffness refers to a value measured on the color contact lens after the water content of the color contact lens reaches the equilibrium water content at room temperature. In this case, the stiffness may be obtained by multiplying the Young modulus by the product of thickness of a lens at a certain point. As one example, the stiffness of the center of the optical zone may be obtained by calculating the product of the thickness of a lens at the center of the optical zone, and multiplying the Young modulus of the lens by the product of the thickness of the lens.

One embodiment of the color contact lens of the present invention may further include an additive, when necessary. In this case, the additive may include a coloring agent, an ultraviolet (UV) blocking agent, a UV sunscreen agent, and the like. The color contact lens according to the present invention may realize colors without using a coloring agent such as a dye or a pigment. However, it should not be understood that the color contact lens according to the present invention excludes the coloring agent. According to one specific embodiment, an aspect of the color contact lens, which further includes a color pattern printed on one surface of the annular peripheral zone, which includes a plurality of photonic crystal structures dispersed around the optical zone, using a coloring agent, also falls within the scope of the present invention.

Further, the present invention provides a method of preparing a color contact lens. In this case, the method of preparing a color contact lens includes: (A) preparing a colloidal dispersion including colloidal particles and a multifunctional monomer; (B) forming regularly arranged colloidal crystals from the colloidal dispersion; (C) curing the colloidal crystals to prepare photonic crystal structures; (D) disposing the photonic crystal structures in a mold and filling the mold with a polymerizable composition; and (E) curing the polymerizable composition to encapsulate the photonic crystal structures with a lens material.

In the step (A), the colloidal particles may be preferably monodispersed colloidal particles, and may be substantially spherical particles. The colloidal particles may be high-molecular particles or inorganic particles, and may have a diameter of 50 nm to 500 nm. The multifunctional monomer may be dissolved in a solvent, or may be used alone without using a solvent. In this case, the multifunctional monomer may be used as a medium to form a dispersion including the colloidal particles at a concentration of 5 to 60% by volume. Preferably, the colloidal particles may be included at 10 to 50% by volume, and more preferably 20 to 40% by volume.

The medium including the multifunctional monomer may further include a thermal initiator or a photoinitiator for a subsequent curing reaction, and preferably may further include a photoinitiator.

In the step (B), the colloidal dispersion may be self-assembled by an electrostatic repulsive force to induce a regular arrangement, or self-assembled by means of a precipitation method to induce a regular arrangement, but this is just one embodiment, and the present invention is not limited thereto. In this case, methods known in the related art for inducing the regular arrangement of the colloidal particles may be used without any limitation.

In the step (C), when the regularly arranged colloidal crystals are obtained, the multifunctional monomer included as the medium may be cured to fix the colloidal crystals with the wall material, and the photonic crystal structures may be prepared accordingly.

The curing reaction may be a thermosetting reaction using a thermal initiator, or a photocuring reaction using a photoinitiator. Preferably, the curing reaction may be a photocuring reaction.

The photonic crystal structures obtained through the curing reaction may be in a lamellar or hemispherical shape having a thickness of 1 μm to 50 μm, and the colloidal particles may be stacked in five or more layers in a direction of depth (d2) of the photonic crystal structures. Also, the photonic crystal structures may have an in-plane long-axis diameter of 10 μm to 1,000 μm, and the plurality of photonic crystal structures may have the same or different long-axis diameters.

The step (D) includes disposing the photonic crystal structures at a certain position in the mold and filling the mold with a polymerizable composition for preparing a hydrogel. Preferably, the photonic crystal structures may be disposed at a certain corresponding position in the mold so that the photonic crystal structures can be positioned in the annular peripheral zone of the contact lens. Thereafter, the mold may be filled with the polymerizable composition for preparing a hydrogel. In this case, a gap g between the neighboring photonic crystal structures may be in a range of 10 μm to 500 μm.

The polymerizable composition for preparing a hydrogel may be a polymerizable composition including one or more monomers containing a polymerizable functional group, and the hydrogel may be a silicone-based hydrogel or an acrylic hydrogel.

In the step (E), the polymerizable composition for preparing a hydrogel may be cured to prepare the color contact lens according to the present invention. In this case, the photonic crystal structures may be encapsulated into the lens material by means of the curing reaction. The curing reaction of the polymerizable composition may be carried out under initiation by heat or light, but this is just one embodiment, and the present invention is not limited thereto.

One embodiment of the method of preparing a color contact lens according to the present invention may further include removing the colloidal particles from the photonic crystal structures after the step (C). The removal of the colloidal particles may be carried out after the step (C) and before the step (D), or may be carried out after the step (E) in which the contact lens is prepared.

The removal of the colloidal particles may be carried out by means of etching, dissolution using a solvent, or thermal treatment. A number of pores may be formed in the wall material through the removal of the colloidal particles. According to one specific embodiment, when the colloidal particles are silica particles, only the silica particles may be selectively removed through HF etching.

As such, the color contact lens according to the present invention has an effect of providing a color contact lens capable of realizing various colors by varying the size of the pores dispersed in the photonic crystal structures without using a coloring agent. Also, the color contact lens according to the present invention has an effect of not losing colors of the structural color, even when the hydrogel serving as the lens material is hydrated or swollen, because the photonic crystal structures are fixed with the wall material serving as the non-swelling cross-linked polymer. Moreover, the color contact lens according to the present invention may minimize the generation of local stress during the hydration or swelling of the hydrogel because the plurality of photonic crystal structures are disposed in the form of particles to be spaced apart from each other, thereby preventing the bending or deformation in the shape of the contact lens. Further, the color contact lens according to the present invention may realize colors through the photonic crystal structures, and thus has an advantage in that the color contact lens is fundamentally harmless to the human body because a chemical dye or pigment is not used.

Also, the color contact lens according to the present invention has an advantage in that, because the contact lens may include the micro-pattern capable of realizing various colors without any dependence on the lens material, the lens material having both high water content and oxygen permeability may be used to achieve color characteristics, a high water content, and high oxygen permeability.

The pigment-free color contact lens including a micro-pattern in which the photonic crystal structures are distributed according to the present invention will be described in further detail with reference to examples thereof. However, it should be understood that the following examples are just references for describing the present invention in detail, but are not intended to limit the present invention, which may be embodied in various forms.

Unless otherwise defined, all the technical and scientific terms have the same meaning as commonly understood by one of ordinary skill in the art to which the invention pertains. The terms used in the detailed description are intended to effectively describe the specific embodiments, and are not intended to limit the present invention.

Also, the units of additives which are not particularly described in this specification may be a percent (%) by weight.

[Measurement Method of Properties]

1. Water Content

The water content (%) was estimated using Equation 2 below by measuring a weight of a dry contact lens, and a weight of a contact lens, which was swollen after immersion in 0.9% by weight of an aqueous sodium chloride (NaCl) solution for 24 hours. That is, the water content was estimated as a ratio of a weight (W_{swell}) of the swollen contact lens with respect to a weight (W_{dry}) of the dry contact lens.

Water content (%)=(W_{swell}−W_{dry})/W_{dry}×100 [Equation 2]

### EXAMPLE 1

Silica particles having an average diameter of 205 nm, prepared using a Stober method, were dispersed at a volume fraction of 30% in Ethoxylated trimethylolpropane triacrylate (ETPTA), and 2-hydroxy-2-methyl-1-phenyl-1-propanone as a photoinitiator was further added at a content of 0.3% by weight, based on the total weight of the resulting mixture. Thereafter, the mixture was dispersed to prepare a colloidal dispersion. Then, the colloidal dispersion was applied on an engraved plate having an engraved portion in which a particle pattern in a hemispherical shape was engraved to a depth of 12 μm, and the portions other than the engraved portion were subjected to blading treatment. The pattern was transferred onto a lower contact lens mold from the engraved plate using a stamp, and cured by irradiation with UV rays at a luminous intensity of 200 mW/cm² for 10 seconds to prepare photonic crystal structures. In this case, a wall material of the prepared photonic crystal structures had a water content of 1.2%.

2-Hydroxyethyl methacrylate (HEMA) as a monomer for preparing a hydrogel, and ethylene glycol dimethacrylate (EGDMA) as a cross-linking agent were dispersed at a weight fraction of 95% and 5%, respectively, to prepare a polymerizable composition for preparing a hydrogel. Thereafter, 0.3% by weight of 2-hydroxy-2-methyl-1-phenyl-1-propanone was further added, based on the total weight of the polymerizable composition, and then dispersed. 50 μL of the polymerizable composition was dropped on the lower contact lens mold in which the photonic crystal structures were positioned, and an upper contact lens mold was then covered. Subsequently, the polymerizable composition was cured by irradiation with UV rays at a luminous intensity of 200 mW/cm² for 50 seconds. Then, the upper contact lens mold was removed to obtain a final color contact lens. In this case, the water content of the hydrogel prepared from the polymerizable composition was 51%.

The prepared color contact lens is shown in FIG. 6. Here, the color contact lens showed the same brown structural color before swelling and even during swelling in water, and no bending or deformation also occurred in the shape of the contact lens.

### EXAMPLE 2

A contact lens was prepared in the same manner as in Example 1, except that silica particles having an average diameter of 185 nm were used.

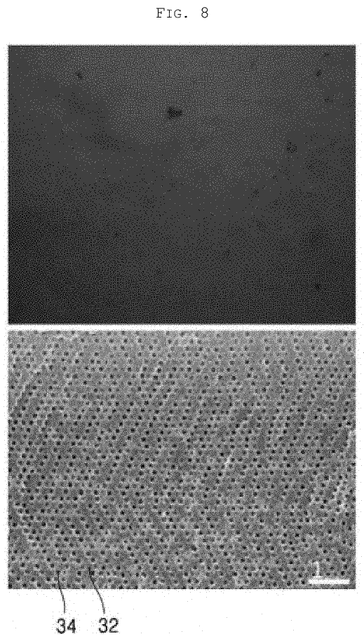

The prepared color contact lens is shown in FIG. 7. Here, the color contact lens showed the same green structural color before the swelling and even during the swelling in water, and no bending or deformation also occurred in the shape of the contact lens.

### EXAMPLE 3

A contact lens was prepared in the same manner as in Example 1, except that silica particles having an average diameter of 165 nm were used.

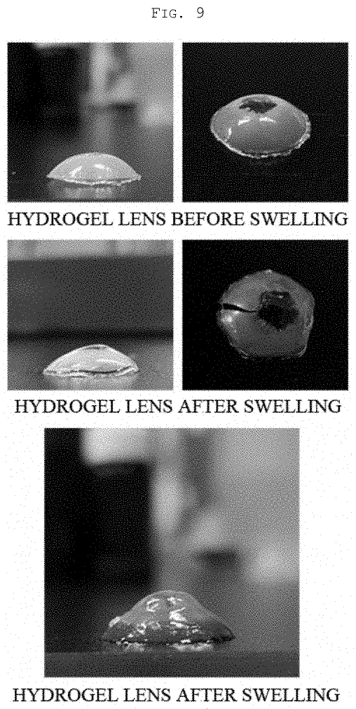

The prepared color contact lens is shown in FIG. 8. Here, the color contact lens showed the same blue structural color before the swelling and even during the swelling in water, and no bending or deformation also occurred in the shape of the contact lens.

### EXAMPLE 4

The colloidal dispersion prepared in Example 1 was applied on an engraved plate having an engraved portion in which a particle pattern in a hemispherical shape was engraved to a depth of 5 μm, and the portions other than the engraved portion were subjected to blading treatment. The pattern was transferred onto a lower contact lens mold from the engraved plate using a stamp, and then cured by irradiation with UV rays at a luminous intensity of 200 mW/cm² for 10 seconds to prepare photonic crystal structures. As described above, photonic crystal structures were also further prepared from the colloidal dispersion prepared in Example 2.

The respective photonic crystal structures prepared as described above were mixed at a weight ratio of 1:1, and disposed on an engraved plate having an engraved portion in which a particle pattern in a hemispherical shape was engraved to a depth of 12 μm. An empty space of the engraved portion was filled with the polymerizable composition prepared in Example 1, and the portions other than the engraved portion were then subjected to blading treatment. The pattern was transferred onto a lower contact lens mold from the engraved plate using a stamp, and then cured by irradiation with UV rays at a luminous intensity of 200 mW/cm² for 10 seconds to form a pattern including the different photonic crystal structures.

Next, 50 μL of the polymerizable composition was dropped on the lower contact lens mold in which the photonic crystal structures were positioned, and an upper contact lens mold was then covered. Subsequently, the polymerizable composition was cured by irradiation with UV rays at a luminous intensity of 200 mW/cm² for 50 seconds. Then, the upper contact lens mold was removed to obtain a final color contact lens.

The prepared color contact lens showed the same yellow structural color before swelling and even during swelling in water, and no bending or deformation also occurred in the shape of the contact lens.

### EXAMPLE 5

The colloidal dispersion prepared in Example 1 was applied on an engraved plate having an engraved portion in which a particle pattern in a hemispherical shape was engraved to a depth of 5 μm, and the portions other than the engraved portion were subjected to blading treatment. The pattern was transferred onto a lower contact lens mold from the engraved plate using a stamp, and then cured by irradiation with UV rays at a luminous intensity of 200 mW/cm² for 10 seconds to prepare photonic crystal structures. As described above, photonic crystal structures were also further prepared from the colloidal dispersion prepared in Example 3.

The respective photonic crystal structures prepared as described above were mixed at a weight ratio of 1:1, and disposed on an engraved plate having an engraved portion in which a particle pattern in a hemispherical shape was engraved to a depth of 12 μm. An empty space of the engraved portion was filled with the polymerizable composition prepared in Example 1, and the portions other than the engraved portion were then subjected to blading treatment. The pattern was transferred onto a lower contact lens mold from the engraved plate using a stamp, and then cured by irradiation with UV rays at a luminous intensity of 200 mW/cm² for 10 seconds to form a pattern including the different photonic crystal structures.

Next, 50 μL of the polymerizable composition was dropped on the lower contact lens mold in which the photonic crystal structures were positioned, and an upper contact lens mold was then covered. Subsequently, the polymerizable composition was cured by irradiation with UV rays at a luminous intensity of 200 mW/cm² for 50 seconds. Then, the upper contact lens mold was removed to obtain a final color contact lens.

The prepared color contact lens showed the same magenta structural color before swelling and even during swelling in water, and no bending or deformation also occurred in the shape of the contact lens.

### EXAMPLE 6

Photonic crystal structures were prepared in the same manner as in Example 1, except that the silica particles having an average diameter of 205 nm, prepared using a Stober method, were dispersed at a volume fraction of 30% in a mixture obtained by mixing Ethoxylated trimethylolpropane triacrylate (ETPTA) and 2-hydroxyethyl methacrylate (HEMA) at a weight ratio of 1:1, and 0.3% by weight of 2-hydroxy-2-methyl-1-phenyl-1-propanone as a photoinitiator was further added at a content of 0.3% by weight, based on the total weight of the resulting mixture, and dispersed. In this case, the water content of the wall material of the photonic crystal structures was 33%.

The prepared color contact lens showed a blue structural color before swelling, but the structural color disappeared during the swelling in water.

### EXAMPLE 7

A polymerizable composition for preparing a hydrogel, in which dimethacryloyl silicone-containing macromer (M3U), N-vinyl-N-acetamide (VMA), and methylmethacrylate (MMA) were dispersed at a weight ratio of 35:48:17, respectively, was prepared, and 0.3% by weight of 2-hydroxy-2-methyl-1-phenyl-1-propanone was further added, based on the total weight of the polymerizable composition, and then dispersed. A compound, which had the following structural formula (where n=121, m=7.6, and h=4.4) and had a weight average molecular weight of 16,200 g/mol, was used as the M3U.

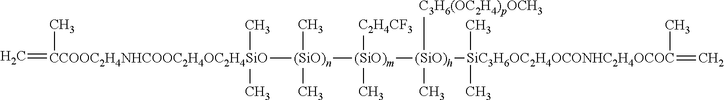

50 μL of the polymerizable composition was dropped on a lower contact lens mold in which the photonic crystal structures prepared in Example 1 were positioned, and an upper contact lens mold was then covered. Subsequently, the polymerizable composition was cured by irradiation with UV rays at a luminous intensity of 200 mW/cm² for 50 seconds. Then, the upper contact lens mold was removed to obtain a final color contact lens. In this case, the water content of the hydrogel prepared from the polymerizable composition was 46%.

The prepared color contact lens showed the same brown structural color before swelling and even during swelling in water, and no bending or deformation also occurred in the shape of the contact lens.

### COMPARATIVE EXAMPLE 1

A contact lens was prepared in the same manner as in Example 1, except that an engraved plate having an engraved portion in which a ring pattern was engraved was used as the engraved plate having an engraved portion in which the pattern was engraved. Specifically, an annular ring pattern, which had been generated through the engraved plate having the engraved portion in which the ring pattern was engraved, was transferred onto a lower contact lens mold from the engraved plate, and a hydrogel was prepared in the same manner as in Example 1 to obtain a final color contact lens.

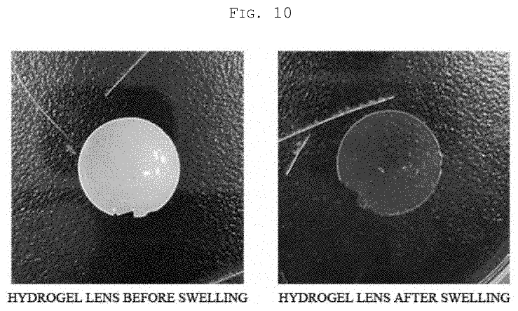

The prepared color contact lens is shown in FIG. 9. Here, all in-plane curvatures of the color contact lenses were maintained at a constant level before the swelling, but a distortion or breakage phenomenon occurred during the swelling in water due to a difference in swelling ratio between the annular peripheral zone and the optical zone.

### COMPARATIVE EXAMPLE 2

2-Hydroxyethyl methacrylate (HEMA) as a monomer for preparing a hydrogel, and ethylene glycol dimethacrylate (EGDMA) as a cross-linking agent were dispersed at a weight fraction of 95% and 5%, respectively, to prepare a polymerizable composition for preparing a hydrogel. Thereafter, the silica particles having an average diameter of 205 nm, prepared using a Stober method, were dispersed at a volume fraction of 30% in the polymerizable composition, and 0.3% by weight of 2-hydroxy-2-methyl-1-phenyl-1-propanone was further added, based on the total weight of the polymerizable composition, and then dispersed.

50 μL of the polymerizable composition including the silica particles was dropped onto a lower contact lens mold, and an upper contact lens mold was then covered. Subsequently, the polymerizable composition was cured by irradiation with UV rays at a luminous intensity of 200 mW/cm² for 50 seconds. Then, the upper mold was removed to obtain a final color contact lens.

The prepared color contact lens is shown in FIG. 10. Here, the color contact lens showed a blue structural color before the swelling, but the structural color disappeared during the swelling in water.

The color contact lens according to the present invention has advantages in that the color contact lens can realize various colors without using a pigment, and can have a high water-swelling property, and no bending or deformation occurs in the shape of the contact lens even when swollen.

Also, the color contact lens according to the present invention has advantages in that no color distortion or change occurs even when the contact lens is swollen, and color characteristics are maintained even after repeated wearing of the contact lens.

Further, the color contact lens according to the present invention has an advantage in that the contact lens has excellent flexibility.

Although the present invention has been described with reference to preferred embodiments thereof, it should be understood that the present invention is not intended to be limiting, and various modifications and variations can be made to the present invention without departing from the scope of the present invention.

### DETAILED DESCRIPTION OF MAIN ELEMENTS

10: contact lens
20: lens body
30: photonic crystal structure
32: wall material of the photonic crystal structures
34: pore
d1: diameter of photonic crystal structures
d2: depth of photonic crystal structures
g: gap between photonic crystal structures

What is claimed is:

1. A color contact lens comprising:
a hydrogel; and
a micro-pattern in which a plurality of photonic crystal structures included in the hydrogel are dispersed.

2. The color contact lens of claim 1, wherein the photonic crystal structures comprise opal or inverse opal structures.

3. The color contact lens of claim 1, wherein the photonic crystal structures are in a lamellar or hemispherical shape having a thickness of 1 μm to 50 μm.

4. The color contact lens of claim 1, wherein the photonic crystal structures have substantially spherical particles or spherical pores regularly arranged therein, and a wall material of the photonic crystal structures comprises a polymer having a water content of 0 to 30%.

5. The color contact lens of claim 4, wherein the wall material of the photonic crystal structures comprises a cross-linked polymer which is not swellable in water.

6. The color contact lens of claim 4, wherein the polymer of the wall material is prepared by polymerizing a monomer composition comprising 50 mol % or more of a multifunctional monomer containing two or more polymerizable functional groups, based on the total moles of monomers in a monomer composition.

7. The color contact lens of claim 1, wherein the photonic crystal structures are derived from colloidal photonic crystal structures in which crystals are spontaneously formed by a repulsive force acting between colloidal particles and a solvent.

8. The color contact lens of claim 1, wherein the color contact lens is pigment-free contact lens which is not comprise a coloring agent.

9. The color contact lens of claim 1, wherein the micro-pattern is included in an annular peripheral zone.

10. A color contact lens comprising:
an optical zone through which a contact lens wearer's line of vision passes; and
an annular peripheral zone comprising a plurality of photonic crystal structures dispersed around the optical zone,
wherein the plurality of photonic crystal structures are encapsulated with a lens material.

11. The color contact lens of claim 10, wherein the plurality of photonic crystal structures dispersed in the annular peripheral zone form an annular, semi-annular, crescentic, or arch-shaped strip.

12. The color contact lens of claim 10, wherein the lens material comprises an acrylic or silicone-based hydrogel.

13. The color contact lens of claim 10, wherein a water content of the lens material is higher than water contents of the plurality of photonic crystal structures.

14. The color contact lens of claim 10, wherein the photonic crystal structures have an in-plane long-axis diameter of 10 μm to 1,000 μm, and the plurality of photonic crystal structures have the same or different long-axis diameters.

15. The color contact lens of claim 10, wherein the photonic crystal structures have substantially spherical particles or spherical pores regularly arranged therein, and the spherical particles or spherical pores have a diameter of 50 nm to 500 nm.

16. The color contact lens of claim 10, wherein a gap between the photonic crystal structures is in a range of 10 μm to 500 μm.

17. The color contact lens of claim 10, wherein the color contact lens has a water content of 35% or more and an oxygen permeability (Dk) of 50 or more.

18. A method of preparing a color contact lens, comprising:
(A) preparing a colloidal dispersion comprising colloidal particles and a multifunctional monomer;
(B) forming regularly arranged colloidal crystals from the colloidal dispersion;
(C) curing the colloidal crystals to prepare photonic crystal structures;
(D) disposing the photonic crystal structures in a mold and filling the mold with a polymerizable composition; and
(E) curing the polymerizable composition to encapsulate the photonic crystal structures with a lens material.

19. The method of claim 18, further comprising removing the colloidal particles from the photonic crystal structures after the step (C).
